(19) United States
(12) Patent Application Publication
(10) Pub. No.: US 2006/0013609 A1
(43) Pub. Date: Jan. 19, 2006

(54) Machine user interface including a selected service details content well

(75) Inventors: Andrew T. Martin, Honeoye Falls, NY (US); Karen Totten, Macedon, NY (US); Shane Jewitt, Rochester, NY (US); Marc J. Krolczyk, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation.

(21) Appl. No.: 10/892,638

(22) Filed: Jul. 16, 2004

(51) Int. Cl. G03G 15/00

(52) U.S. Cl. 399/81

(57) ABSTRACT

A touch-based machine User interface (UI) including (a) bar regions for displaying menu headings and command icons; (b) a UI work area; (c) a dedicated machine function selection pane within the UI work area including a series of selectable machine functions and function icons; (d) an associated controller connected to and controlling the series of selectable machine functions; (e) a programmable selected machine function details content well for displaying details and additional information associated with a selected one of the machine function icons; and (f) means for selectively customizing, for a user, the programmable selected machine function details content well from a display to a non-display mode, thereby enabling increased user satisfaction and user productivity on the multi-function machine.

### CROSS-REFERENCE TO RELATED APPLICATIONS

This application is a utility version of Applicant's design patent application U.S. Ser. No. ______ filed ______ [Applicant's Docket No. DS/A3343].

The present disclosure is directed to user interfaces (UI's), and more specifically, to a touch-based machine UI including a programmable selected document service details content well that is useful for increasing user satisfaction and productivity.

A conventional reprographic machine is the office copier. Traditionally, the copier, in the office equipment context, refers to a light lens xerographic copier in that paper originals are in fact photographed. The images are focused on an area of a photoreceptor, that is subsequently developed with toner. The developed image on the photoreceptor is then transferred to a copy sheet that in turn is used to create a permanent copy of the original.

In recent years, however, there has been made available what is known as digital copiers or printing machines. In the most basic functions, a digital copier or printing machine performs the same functions as a light lens copier, except that includes a programmable controller for controlling its functions, and the original image to be copied is not directly focused on a photoreceptor. Instead, with a digital copier or printer, the original image is received, for example, from a personal computer (PC) work station, or storage media, or is scanned by a device generally known as a raster input scanner (RIS) that is typically in the form of a linear array of small photosensors. The controller further enables a wide range of image manipulation and processing capabilities.

The original image received as such is focused on the photosensors in the RIS. The photosensors convert the various light and dark areas of the original image to a set of digital signals. These digital signals are temporarily retained in a memory and then eventually are further processed, and manipulated/and or used as is with the aid of a user interface (UI) assembly, to operate the digital printing machine or copier when it is desired to print copies of the original. The digital signals may also be sent directly to the digital printing machine or copier without being stored in a memory. Typically, each such digital printing machine or copier.

Digital printing machines or copiers as such are currently being used in the market place of the general office environment. Usually such machines are used in this environment on a non-dedicated and casual basis, as well as by users of varying skill levels, including the most basic level. At the same time, such digital printing machines or copiers are also being used by highly skilled and experienced operators, in a dedicated manner, within the centralized reprographic departments (CRD's) of large corporations or in key operator Quick Printing Shops.

As disclosed for example in commonly owned U.S. Pat. No. 6,470,155, issued Oct. 22, 2002 to Martin, et al, it is known to provide a machine for example with dual selectable User Interfaces, each directed to a different skill level. However, currently the method within each level of User Interface for selecting Document Services (Copy, Fax, Scan to Email etc) on multifunction devices is not flexible enough to allow it to conform to a customers desired workflow, and some cases it fails to provide sufficient required information to users regarding the functionality details contained within each of the available services.

In addition, it is known for example, as is available on some WINDOWS operating systems, to anticipate the information needs of an application user, and pre-display such information or an outline for such information. Such anticipatory display is often unnecessary, or eventually becomes unnecessary, and so becomes a source of dissatisfaction. Even for those displays that provide a means for opting out, there is no easy or automatic means for re-accessing such information when required.

There is therefore a need for a machine optimized UI and a reprographic machine having same, for increasing user satisfaction and productivity on the same reprographic machine.

In accordance with the present disclosure, there is provided a touch-based machine User interface (UI) including (a) bar regions for displaying menu headings and command icons; (b) a UI work area; (c) a dedicated machine function selection pane within the UI work area including a series of selectable machine functions and function icons; (d) an associated controller connected to and controlling the series of selectable machine functions; (e) a programmable selected machine function details content well for displaying details and additional information associated with a selected one of the machine function icons; and (f) means for selectively customizing, for a user, the programmable selected machine function details content well from a display to a non-display mode, thereby enabling increased user satisfaction and user productivity on the multi-function machine

The following is a brief description of the drawings used to describe the present disclosure, and thus, these drawings are being presented for illustrative purposes only and thus should not limit the scope of the present disclosure, wherein:

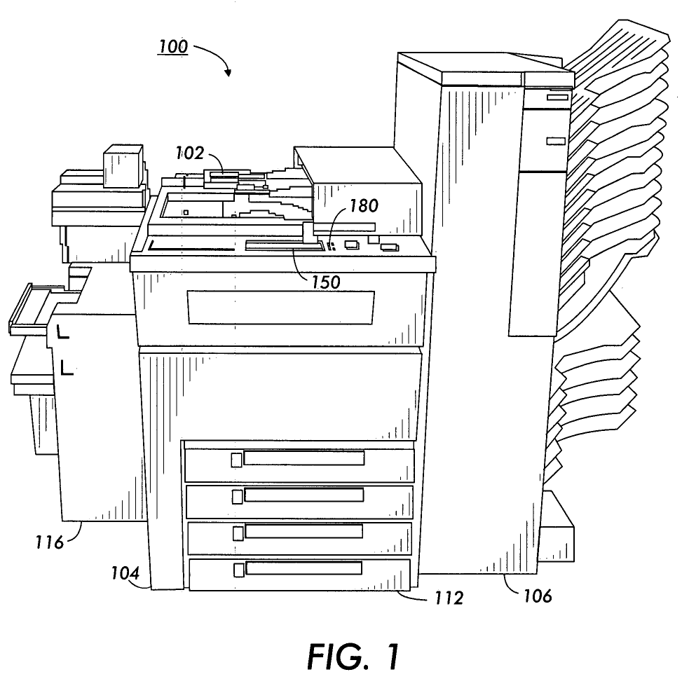

FIG. 1 is an illustration of an image producing reprographic machine including the touch-based machine User Interface (UI) in accordance with the present disclosure;

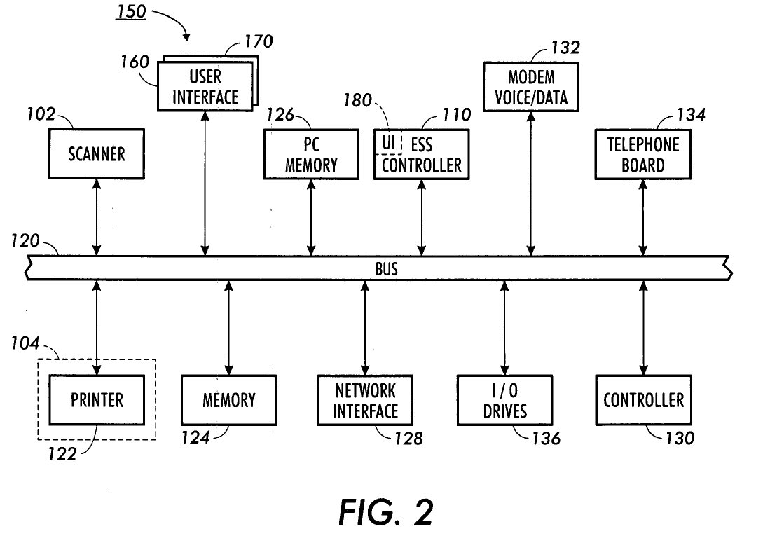

FIG. 2 is a block diagram illustration of the image producing reprographic machine of FIG. 1;

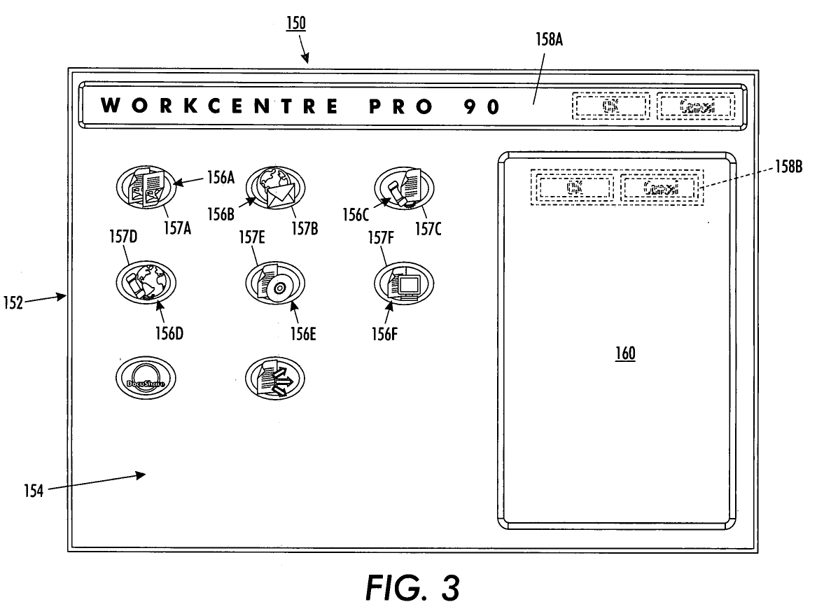

FIG. 3 is an illustration of a first embodiment of the machine function selection pane including a selected function details content well of the present disclosure;

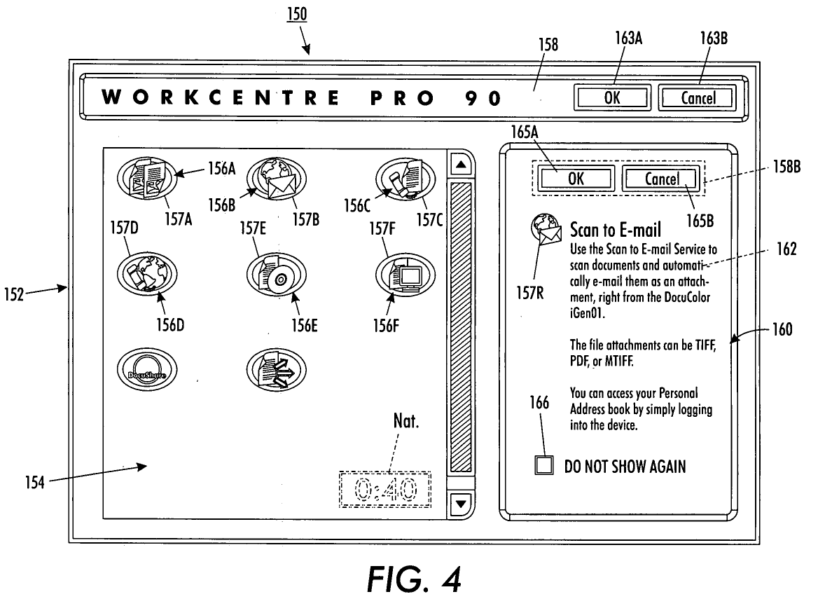

FIG. 4 is an illustration of a second embodiment of the machine function selection pane showing a selected function and related details thereof displayed in the selected function details content well of the present disclosure;

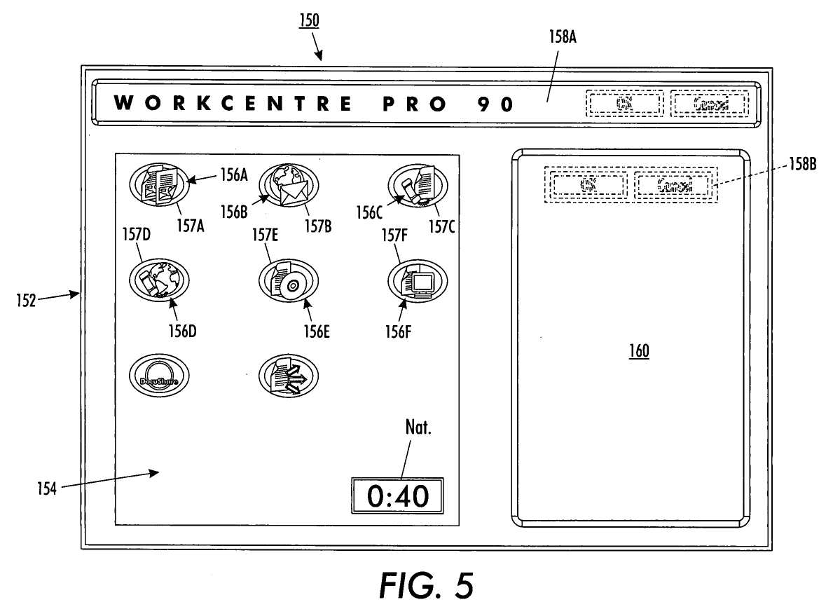

FIG. 5 an illustration of the first embodiment of the machine function selection pane showing the selected function details content well in a DO-NOT-DISPLAY (DND) mode; and

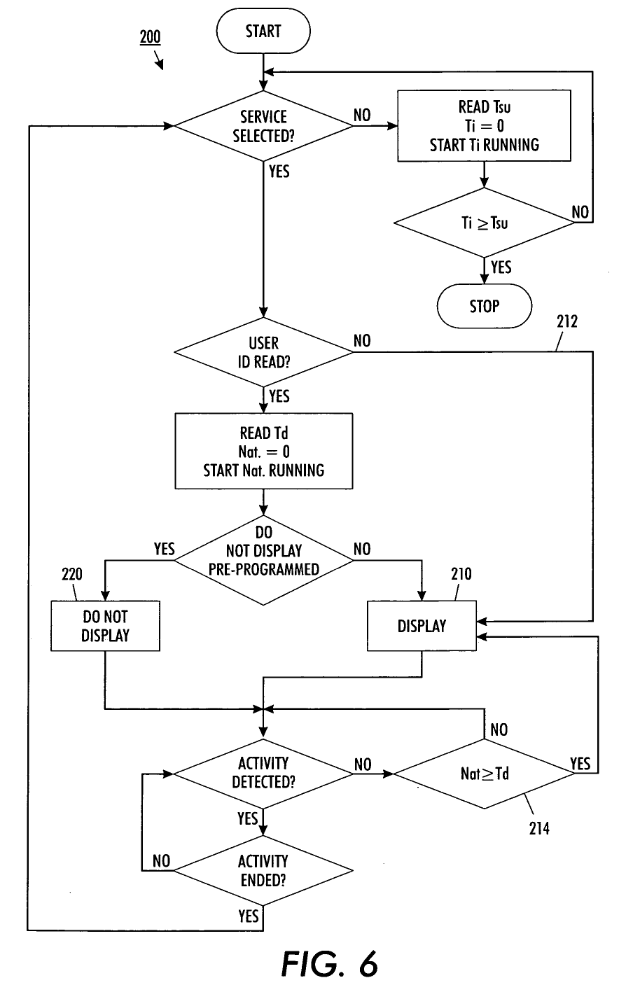

FIG. 6 is a flow chart illustrating operation of the selected function details content well and its controller in accordance with the present disclosure.

The following is a detailed description of the present disclosure. In this description, the drawings have been utilized to illustrate the concepts of the present disclosure. In this description as well as in the drawings, like reference numerals indicate the same items or equivalent items.

Referring now to FIGS. 1-2, an overall construction, and a block diagram, of a digital reprographic machine 100 including the touch-based machine user interface (UI) 150 of the present disclosure, are illustrated. As shown, the digital machine 100 includes a scanning device 102, a printing module 104, and the touch-based machine user interface (UI) 150 (to be described in detail below). The digital machine 100 may also include a finisher device 106 that may be a sorter, tower mailbox or stapler, and at least an electronic subsystem (ESS) controller 110 for controlling all the features and functions of the machine 100. The printing module 104 may include a plurality of paper trays 112 that store image carrying media such as paper that is used in the printing process. Lastly, the digital machine may include a high capacity feeder 116 that is capable of holding large amounts of paper stock to be used by the machine.

In a typical scanning function, the operator would utilize the scanning device 102 to scan in the images from the original documents. This scanning device 102 may be a platen type scanner or may include a constant velocity transport system that moves the original documents across a stationary scanning device. Moreover, the scanning device 102 may also include a document handling system that is capable of placing the original documents, automatically, on the glass platen for scanning.

With respect to the printing functions, the printing module 104 would retrieve the proper paper from one of the multiple paper trays 112 or the high capacity feeder 116, render the desired image on the retrieved paper, and output the printed image to the finishing device 106 for further operations.

An example of the basic architecture of the digital machine 100 is illustrated as a block diagram in detail in FIG. 2, and includes the scanner 102 that converts an original image into a set of digital signals that can be either stored or reproduced. The scanner 102 is connected to a central bus system 120 that may be either a single bus or a plurality of buses that provide interconnections and intercommunications between the various modules and stations on the digital machine.

The digital machine 100 also includes a digital printing device 122 of the printing module 104 (FIG. 2) that converts digital signals representing an image into a hardcopy of that image on a recording medium whether the recording medium be paper, transparency, or other type of markable medium. A first memory device 124 is provided for storing a variety of types of digital information such as machine fault information, machine history information, digital images to be processed at a later time, instruction sets for the machine or job instruction sets. A second memory device forming an electronic pre-collation memory section 126 may be provided for storing the digital representation of the image being presently rendered by the digital printing device 122. In the electronic pre-collation memory 126, the digital image is already laid out in its page structure so that it can be readily rendered by the digital printing device 122.

Since the digital machine 100 may be connected to a network including a PC work station (not shown), it includes a network interface 128 and an additional controller 130 that control the interrelationship between the various modules or stations on the digital machine 100 and the network.

In cases where the digital machine 100 is a multi-function machine, it would include, typically, a voice/data modem 132 and a telephone circuit board 134. Moreover, the digital machine may also include input/output drives 136 such as a floppy disc drive, a CD ROM drive, a tape drive, or other type of drive that can accept a portable memory device.

Referring now to FIGS. 1-6, the digital machine 100, in accordance with the present disclosure, includes the touch-based machine user interface (UI) 150 for increasing user satisfaction and productivity on a multi-function image production machine. The touch-based machine user interface (UI) 150 with the aid of the controller 110, effectively enables the user to control, within each user interface level, the amount of information needed for maintaining user productivity and user satisfaction.

Referring in particular to FIGS. 3 and 4, the touch-based machine UI 150 includes (a) bar regions 158A, 158B for displaying menu headings and command icons 163A, 163B (on the pane 152), and 165A, 165B (well 160); (b) a UI work area 154; (c) a dedicated machine function selection pane 152 within the UI work area that includes a series of selectable machine functions 156A-F for example, and associated function icons 157A-F; (d) an associated controller 110 connected to and controlling the series of selectable machine functions 156A-F; (e) a programmable selected machine function details content well 160 for displaying details 162 and additional information associated with a selected one of the machine function 156A-F for example; and (f) devices 110, 180, 200 for selectively customizing, for a user, the programmable selected machine function details content well 160 from a display mode 210 (FIG. 6) to a non-display mode 220, thereby enabling increased user satisfaction and user productivity on the multi-function machine.

As illustrated in FIGS. 3-5, the service selection pane 152 is a dedicated window, within the User Interface dialog or work area 154, that is used for the selection of machine document services or functions 156A-F for example. The service selection pane 152 thus includes icons, such as buttons, for the selectable multi-function machine document services 156A-F. The service selection pane 152 also includes the programmable selected machine function details content well 160 that is a dedicated area for programmably displaying detail information 162 on any of the selected multi-function machine document services 156A-F for example.

As additionally illustrated in FIG. 6, in accordance with an aspect of the present disclosure, there is provided a method for customizing the behavior of the programmable selected machine function details content well 160 in order to allow for time to time variations in customer need for additional or incremental details information. As pointed out above, the machine document service selection pane or window 152 includes the series of mutually exclusive document service selection functions 156A-F with icons 157A-F, such as buttons, one per each available service or function.

As a default, or based on pre-programming to the display mode 210, the basic behavior of the programmable selected machine function details content well 160 is that as a user selects one of the icons 157A-F for one of the mutually exclusive machine document services 156A-F for example, the detailed information 162 displayed within the programmable selected machine function details content well 160 will automatically be updated to display detailed content for the one selected service. Such displayed detailed information or content 162 helps users understand the specifics of each function of the different machine documents services, as well as any special capabilities within each service. Using the programmable selected machine function details content well 160 as such, a user could quickly browse through all the various services available in order to make a decision on the best and most appropriate service for them.

Once the user has decided on the best and most appropriate service 156A-F, selection of its icon 157A-F will display the detailed information or content 162 on the selected service within the programmable selected machine function details content well 160. Then, after reading the displayed content 162, or being sure the user understands how to properly use the selected service, the user can directly close the programmable selected machine function details content well 160 by touching on the “OK” command button 165A in the bar region 158B of the content well 160. Selecting the “OK” command button 165A as such, closes the programmable selected machine function details content well 160, and presents a new dialog box (not shown) for the selected service 156A-F.

In accordance with an aspect of the present disclosure, the programmable selected machine function details content well 160 appears recessed relative to a rest of the dedicated machine function or service selection pane 152 for enhancing and directing user attention to content 162 displayed therein. The series of selectable machine function icons 156A-F for example include a Copy icon, a Scan icon, and an email icon. The programmable selected machine function details content well 160 additionally displays a copy 157R of the selected one of the series of selectable machine function icons 157A-F within the programmable selected machine function details content well 160. The means or devices for selectively customizing the programmable selected machine function details content well 160 include a device 180 for reading and authenticating an operator identification, the controller 110, and the program 166, 200 as shown in FIG. 6.

In one embodiment, the means or devices for selectively customizing the programmable selected machine function details content well 160 include reselection means 212 for programming the programmable selected machine function details content well 160 from a non-display mode 220 to a temporary display mode 210. In another embodiment, the means for selectively customizing the programmable selected machine function details content well 160 include means 214 for automatically programming of the programmable selected machine function details content well from a non-display mode to a temporary display mode if there is no activity for a pre-determined period of time following selection of one of the machine function icons.

The method or manner of working of the touch-based machine UI 150 of the present disclosure is illustrated for example in FIG. 6. According to the method as illustrated, when and where more productivity is desired from the machine, and in cases where a user is already familiar with the detailed information that would be displayed in the programmable selected machine function details content well 160 about the functionality of a particular selected service, the programmable selected machine function details content well 160 as above can be pre-programmed to default to the non-display mode 220. As such, selection of any of the machine service selection icons, or buttons will not display (see FIG. 5) detailed information about the selected service, but will allow the user to go immediately to the dialog or activity screen (not shown). This saves a step in the process, thus speeding up the process and increasing productivity.

In particular as illustrated in FIG. 6, when the machine is started and the service selection window or pane 152 is launched, the controller 110 expects one of the selectable service functions to be selected. If not, the program will stop when Ti (time waiting for a service selection) reaches or exceeds a predetermined time limit Tsu. If a service function is selected, the program reads and checks the user's ID. It then reads a predetermined time Td for waiting for an activity, and starts the clock running, Nat. (time waiting for activity selection). It then checks to see if this particular user of the ID had preprogrammed the selected function for a DO-NOT-DISPLAY (DND) mode 220. If not, the content well 160 defaults to the DISPLAY (D) mode 210. If the DND mode 220 had previously been preprogrammed, then the content well 160 switches to the DND mode. In any case, the program continues to check for activity that indicates that the user understands the service function selected, and has made a decision. As a result of such checking, even if the DND mode had previously been preprogrammed the will default to the DISPLAY (D) mode if Nat. (time waiting for activity selection) also equals or exceeds Td. Once activity is detected, the program then checks for its completion, as well as for selection of another service function.

The bar region 158A of the Service selection window or that 158B of the content well 160 as shown, contain command icons or buttons, for example an “OK” and a “Cancel” command icons. In operation, when the content well 160 is in the default display mode 210 and detailed information is displayed, the “Cancel” icon 163B, 165B will be displayed in the bar region in an off or unselectable state. As such it will appear grayed out and non-interactive. However, when the selection pane 152 is launched or returned to from a service content well 160, the “Cancel” button 163B will display a selectable state.

In one aspect of the present disclosure, one service selection icon may always be selected as a default service with the content well 160 in the default display mode 210, thus displaying detailed information 162 on the default service in the content well 160. For example, the “Copy” service selection function and icon” can be such a default service, and so the detailed service information content well 160 will be displaying the associated details content for the copying function. If the “copy” service function is that desired by the user, then selection or a single press and release of the “OK” button in the bar region 158A will launch the associated dialog for the “Copy” service. Optionally, instead of pressing and releasing the “OK” button, the user may reselect, for example, again press and release the currently selected button a second time (double pressing).

However, if instead, another or different service selection button is selected, that is pressed and released, it then replaces the default service and its icon becomes the selected icon. As such, a copy 157R of its icon as well as detail information content 162 about it will be displayed in the content well 160 when the content well 160 is in the display mode 210.

As can be seen, there has been provided a touch-based machine User interface (UI) including (a) bar regions for displaying menu headings and command icons; (b) a UI work area; (c) a dedicated machine function selection pane within the UI work area including a series of selectable machine functions and function icons; (d) an associated controller connected to and controlling the series of selectable machine functions; (e) a programmable selected machine function details content well for displaying details and additional information associated with a selected one of the machine function icons; and (f) means for selectively customizing, for a user, the programmable selected machine function details content well from a display to a non-display mode, thereby enabling increased user satisfaction and user productivity on the multi-function machine.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A touch-based machine User interface (UI) comprising:
(a) bar regions for displaying menu headings and command icons;
(b) a UI work area;
(c) a dedicated machine function selection pane within said UI work area including a series of selectable machine functions and function icons;
(d) an associated controller connected to and controlling said series of selectable machine functions;
(e) a programmable selected machine function details content well for displaying details and additional information associated with a selected one of said machine functions and function icons; and
(f) means for selectively customizing, for a user, said programmable selected machine function details content well from a display mode to a non-display mode, thereby enabling increased user satisfaction and user productivity on the multi-function machine.

2. The touch-based machine UI of claim 1, wherein said programmable selected machine function details content well appears recessed relative to a rest of said dedicated machine function selection pane for enhancing and directing user attention to content displayed therein.

3. The touch-based machine UI of claim 1, wherein said series of selectable machine function icons include a Copy icon.

4. The touch-based machine UI of claim 1, wherein said series of selectable machine function icons include a Fax icon.

5. The touch-based machine UI of claim 1, wherein said series of selectable machine function icons include a Scan icon.

6. The touch-based machine UI of claim 1, wherein said series of selectable machine function icons include an email icon.

7. The touch-based machine UI of claim 1, wherein said programmable selected machine function details content well additionally displays a copy of said selected one of said series of selectable machine function icons within said dedicated machine function selection pane.

8. The touch-based machine UI of claim 1, wherein said means for selectively customizing said programmable selected machine function details content well include a device for reading and authenticating an operator identification.

9. The touch-based machine UI of claim 8, wherein said means for selectively customizing said programmable selected machine function details content well include reselection means for programming said programmable selected machine function details content well from a non-display mode to a temporary display mode.

10. The touch-based machine UI of claim 8, wherein said means for selectively customizing said programmable selected machine function details content well include means for automatically programming of said programmable selected machine function details content well from a non-display mode to a temporary display mode if there is no activity for a pre-determined period of time following selection of one of said machine function icons.

11. An electrostatographic reproduction machine for producing toner images on image carrying media, the electrostatographic reproduction machine comprising:
(a) means for forming a toner image on image carrying media; and
(b) a touch-based machine User interface (UI) comprising:
(i) bar regions for displaying titles and menu headings;
(ii) a UI work area;
(iii) a dedicated machine function selection pane within said UI work area including a series of selectable machine functions and function icons;
(iv) an associated controller connected to and controlling said series of selectable machine functions;
(v) a programmable selected machine function details content well for displaying details and additional information associated with a selected one of said machine function icons; and
(vi) means for selectively customizing, for a user, said programmable selected machine function details content well from a display mode to a non-display mode, thereby enabling increased user satisfaction and user productivity on the multi-function machine.

12. The touch-based machine UI of claim 11, wherein said programmable selected machine function details content well appears recessed relative to a rest of said dedicated machine function selection pane for enhancing and directing user attention to content displayed therein.

13. The touch-based machine UI of claim 11, wherein said series of selectable machine function icons include a Copy icon.

14. The touch-based machine UI of claim 11, wherein said series of selectable machine function icons include a Fax icon.

15. The touch-based machine UI of claim 11, wherein said series of selectable machine function icons include a Scan icon.

16. The touch-based machine UI of claim 11, wherein said series of selectable machine function icons include an email icon.

17. The touch-based machine UI of claim 11, wherein said programmable selected machine function details content well additionally displays a copy of said selected one of said series of selectable machine function icons within said dedicated machine function selection pane.

18. The touch-based machine UI of claim 11, wherein said means for selectively customizing said programmable selected machine function details content well include a device for reading and authenticating an operator identification.

19. The touch-based machine UI of claim 18, wherein said means for selectively customizing said programmable selected machine function details content well include reselection means for programming said programmable selected machine function details content well from a non-display mode to a temporary display mode.

20. The touch-based machine UI of claim 18, wherein said means for selectively customizing said programmable selected machine function details content well include means for automatically programming of said programmable selected machine function details content well from a non-display mode to a temporary display mode if there is no activity for a pre-determined period of time following selection of one of said machine function icons.
